(19) United States
(12) Patent Application Publication
(10) Pub. No.: US 2023/0234104 A1
(43) Pub. Date: Jul. 27, 2023

(54) CLEANING DEVICE FOR CLEANING A MECHANICAL CLEANING ASSEMBLY OF A CLEANING APPARATUS, AND CLEANING SYSTEM

(71) Applicant: CARL FREUDENBERG KG, Weinheim (DE)

(72) Inventors: Willem Lijmbach, Schriesheim (DE); Christian Henn, Viernheim (DE); Christian Stenglein, Frankfurt (DE)

(21) Appl. No.: 17/927,754

(22) PCT Filed: May 10, 2021
(86) PCT No.: PCT/EP2021/062280

§ 371 Date: Nov. 25, 2022

(30) Foreign Application Priority Data
May 29, 2020 (DE) 10 2020 114 451.2

(51) Int. Cl. B08B 3/02; B08B 1/00; A47L 11/30; A47L 11/40

(52) U.S. Cl. CPC B08B 3/02; A47L 11/305; A47L 11/4083; B08B 1/005

(57) ABSTRACT

A cleaning system includes: a cleaning appliance comprising a base member, which is provided with a mechanical cleaning arrangement, and a fluid tank; and a cleaning apparatus for cleaning the mechanical cleaning arrangement of the cleaning appliance, the cleaning apparatus including: a container having a recess for receiving the base member; and a nozzle arrangement associated with the recess. The nozzle arrangement is connected to an inlet in a flow-conducting manner. The fluid tank has an outlet which, to clean the cleaning arrangement, is connectable to the inlet of the cleaning apparatus.

### CROSS-REFERENCE TO PRIOR APPLICATIONS

This application is a U.S. National Phase application under 35 U.S.C. § 371 of International Application No. PCT/EP2021/062280, filed on May 10, 2021, and claims benefit to German Patent Application No. DE 10 2020 114 451.2, filed on May 29, 2020. The International Application was published in German on Dec. 2, 2021 as WO2021/239450 under PCT Article 21(2).

### FIELD

The invention relates to a cleaning apparatus for cleaning a mechanical cleaning arrangement of a cleaning appliance, comprising a container having a recess for receiving the base member, which is provided with the cleaning arrangement, of the cleaning appliance. The invention further relates to a cleaning system comprising a cleaning apparatus and a cleaning appliance.

### BACKGROUND

Such a cleaning appliance is known from US 8,819,882 B2. For cleaning smooth floors, hand-guided or autonomously moving cleaning appliances which have a base member which receives a mechanical cleaning arrangement in the form of a rotatable brush arrangement are used. The cleaning arrangement is caused to rotate by means of an electric motor which is arranged in the base member. The cleaning appliance moves over the floor which is intended to be cleaned and releases dirt which has stuck to the floor by means of the rotating cleaning arrangement.

The cleaning appliance may further be provided with a suction device which has a suction slot which is arranged adjacent to the cleaning arrangement, wherein the suction arrangement receives the dirt which has been released by the cleaning arrangement and conveys it into a dirt container located inside the base member.

The cleaning appliance may further have a device for applying cleaning fluid to the floor to be cleaned. The cleaning fluid comes into contact with the cleaning arrangement, whereby the cleaning arrangement can also release firmly adhering dirt from the floor to be cleaned.

With increasing use, dirt can accumulate on the cleaning arrangement, whereby the cleaning result gradually worsens.

In order to be able to remove dirt from the cleaning arrangement, it is known from the prior art to arrange the base member of the cleaning appliance in a bowl-shaped cleaning apparatus and to clean it at that location.

The cleaning apparatus comprises a container having a recess which is suitable for receiving the base member, which is provided with the cleaning arrangement, of the cleaning appliance. Furthermore, the cleaning apparatus comprises a water reservoir in which a cleaning fluid is located. The cleaning fluid in this instance comes into contact with the cleaning arrangement. In order to clean, the cleaning arrangement of the cleaning appliance is moved, whereby the dirt which is stuck to the cleaning arrangement is released by means of the cleaning fluid. The released dirt reaches the dirt container of the cleaning appliance via the suction slot.

In the previously known cleaning apparatus, it is necessary to fill the cleaning apparatus with a cleaning fluid so that, in addition to the fluid tank of the cleaning appliance, the cleaning apparatus also has to be filled. Furthermore, the capacity of the water reservoir of the cleaning apparatus is limited.

### SUMMARY

In an embodiment, the present invention provides a cleaning system, comprising: a cleaning appliance comprising a base member, which is provided with a mechanical cleaning arrangement, and a fluid tank; and a cleaning apparatus for cleaning the mechanical cleaning arrangement of the cleaning appliance, the cleaning apparatus comprising: a container having a recess configured to receive the base member; and a nozzle arrangement associated with the recess, wherein the nozzle arrangement is connected to an inlet in a flow-conducting manner, and wherein the fluid tank has an outlet which, to clean the cleaning arrangement, is connectable to the inlet of the cleaning apparatus.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a cleaning apparatus;

FIG. 2 shows the cleaning apparatus as a plan view;

FIG. 3 shows a cleaning appliance;

FIG. 4 shows a cleaning system;

FIG. 5 shows a schematic drawing of a cleaning system;

FIG. 6 shows in detail the fluid tank of a cleaning appliance.

### DETAILED DESCRIPTION

In an embodiment, the present invention provides a cleaning apparatus for cleaning a mechanical cleaning arrangement of a cleaning appliance and a cleaning system having a cleaning apparatus and cleaning appliance which enables improved cleaning of the cleaning arrangement.

The cleaning apparatus according to the invention for cleaning a mechanical cleaning arrangement of a cleaning appliance comprises a container having a recess for receiving the base member, which is provided with the cleaning arrangement, of the cleaning appliance, wherein the recess is associated with a nozzle arrangement, wherein the nozzle arrangement is connected to an inlet in a flow-conducting manner.

Via the inlet, cleaning fluid can be supplied to the cleaning apparatus, wherein the cleaning fluid flows out of the nozzle arrangement and cleans the cleaning arrangement of the cleaning appliance at that location. The nozzle arrangement is accordingly arranged in the recess in such a manner that it faces the cleaning arrangement of the cleaning appliance when the cleaning appliance is inserted into the cleaning apparatus.

The inlet enables a cleaning fluid to be supplied to the cleaning apparatus from an external source, wherein the supply can be carried out during the cleaning operation. In this instance, it is particularly advantageous that a cleaning fluid at a preliminary pressure can be introduced via the inlet so that the cleaning fluid leaves the nozzle arrangement in the form of a spray jet. This enables a particularly rapid and effective cleaning of the cleaning arrangement.

The inlet may be in the form of a pipe coupling. For example, the inlet may be in the form of a connection piece on which a container having a water reservoir can be fitted. Sealing means, for example, in the form of an O-ring, may be associated with the inlet.

The nozzle arrangement may be connected to the inlet by means of at least one channel. The nozzle arrangement preferably comprises a plurality of nozzles which are arranged in the recess in such a manner that all regions of the mechanical cleaning arrangement can be reached. To this end, the nozzles of the nozzle arrangement may be arranged one beside the other in a row. However, the nozzles may also be arranged in the form of a grid. Via the channel, the cleaning fluid flows from the inlet in the direction of the nozzle arrangement with the nozzles and leaves the cleaning apparatus via the nozzles.

Flow-conducting devices may be arranged in the channel. The flow-conducting devices can cause the cleaning fluid to flow out of all the nozzles of the nozzle arrangement in a uniform manner.

According to an advantageous embodiment, the flow-conducting device may be in the form of a Tesla valve. A Tesla valve is a passive fluid valve in which the flow resistance in one flow direction is smaller than in the opposite direction. As a result, it is possible for the flow to receive a preferred direction, which in this instance is the direction from the inlet to the nozzle arrangement. In the opposite direction, the flow resistance is significantly increased so that using simple means the risk of backflow of cleaning fluid from the nozzle arrangement in the direction of the inlet can be reduced.

The flow-conducting device may further comprise a valve arrangement. In this instance, it is particularly conceivable for non-return valves and the like to be provided.

Projections may be arranged in the recess. The projections may, for example, be in the form of ribs or studs. As a result of the projections, there is a localized or linear contact of the cleaning arrangement with the projections, which improves the cleaning action. In this instance, the projections may be constructed in a comb-like manner.

The cleaning system according to the invention comprises a cleaning apparatus as described above and a cleaning appliance comprising a base member which is provided with a mechanical cleaning arrangement. The cleaning appliance further comprises a water reservoir and an electric motor, which rotates the cleaning arrangement, and an accumulator which provides electrical energy for the electric motor. The cleaning appliance may further comprise a pump apparatus which conveys the cleaning fluid from the water reservoir in the direction of a nozzle.

The mechanical cleaning arrangement may be a rotatable brush arrangement which has a rotation axis which is orientated parallel with the floor to be cleaned. The brush may have plastics bristles, may be made from a fleece material or also from a microfiber material.

Alternatively, the cleaning arrangement may be a rotatable brush arrangement in which the rotation axis is orientated perpendicularly to the floor to be cleaned. In this instance, it is conceivable for a plurality of, for example, two brushes to be associated with the base member. The brushes may have plastics bristles which are securely connected to the brushes. Furthermore, removable pads made of cleaning textile may be secured to the brushes. The securing of the pads may in this instance be carried out in particular by means of a hook-and-loop fastening. The pad may in this instance be constructed to be both soft and hard and abrasive.

According to another alternative, the cleaning arrangement may be an oscillating cleaning arrangement in which the base member is associated with an oscillating carrier member to which a pad is replaceably secured. In order to clean, this cleaning arrangement carries out an oscillating movement in the longitudinal and/or transverse direction. The pad may in this instance be constructed to be both soft and hard and abrasive.

Furthermore, the base member may further be provided with a suction device having a suction opening. In this instance, the suction opening may be in the form of a suction slot and be arranged adjacent to the cleaning arrangement at the lower side of the base member facing the floor to be cleaned. The suction device is constructed to receive dirt released by the cleaning arrangement and to convey it into a dirt container which is located in the base member of the cleaning appliance.

In order to clean the cleaning arrangement, the cleaning appliance is placed in the recess of the cleaning apparatus and the cleaning arrangement is moved. Cleaning fluid flowing in via the inlet flows out via the nozzle arrangement and the fluid jet flowing out of the nozzle arrangement cleans the cleaning arrangement of the cleaning appliance.

The cleaning appliance may be provided with a fluid tank which comprises an outlet which can be connected to the inlet of the cleaning apparatus in order to clean the cleaning arrangement. The outlet of the fluid tank is in this instance preferably formed in a congruent manner with respect to the inlet and thus arranged on the cleaning appliance in such a manner that the contacting is carried out independently when the cleaning appliance is inserted into the cleaning apparatus. Preferably, there is associated with the outlet a valve which enables cleaning fluid to flow out of the fluid tank via the outlet only when the outlet is connected to the inlet of the cleaning apparatus.

The fluid tank may be acted on with a pressure. This can be carried out using simple means when the cleaning appliance is provided with a pump apparatus. In this embodiment, via the pump apparatus a pressure which is stored in the fluid tank can be generated. This enables, on the one hand, cleaning fluid to flow out via the cleaning nozzle of the cleaning appliance and also a powerful discharge of cleaning fluid via the nozzle arrangement of the cleaning apparatus when the cleaning appliance is placed on the cleaning apparatus.

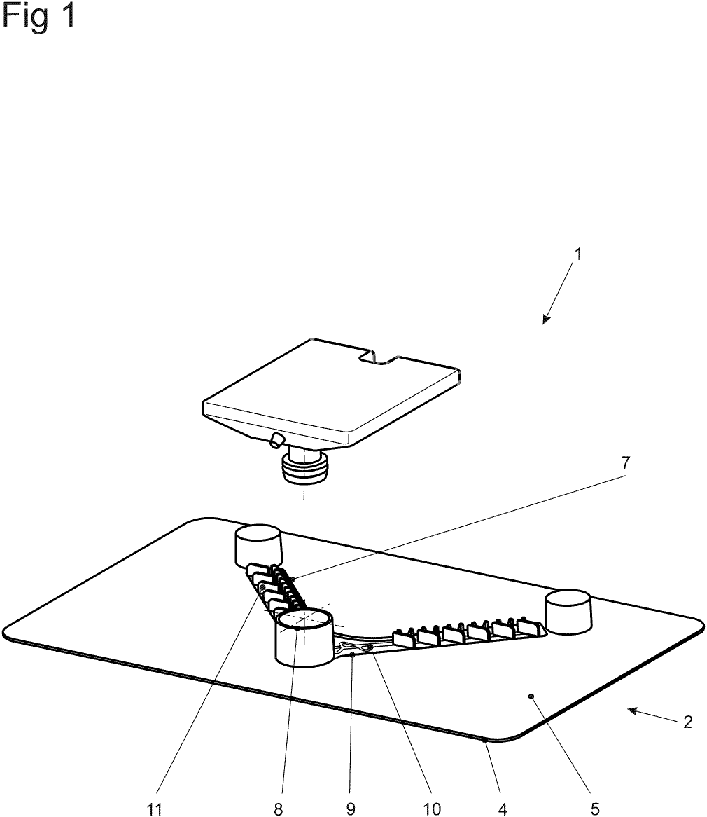

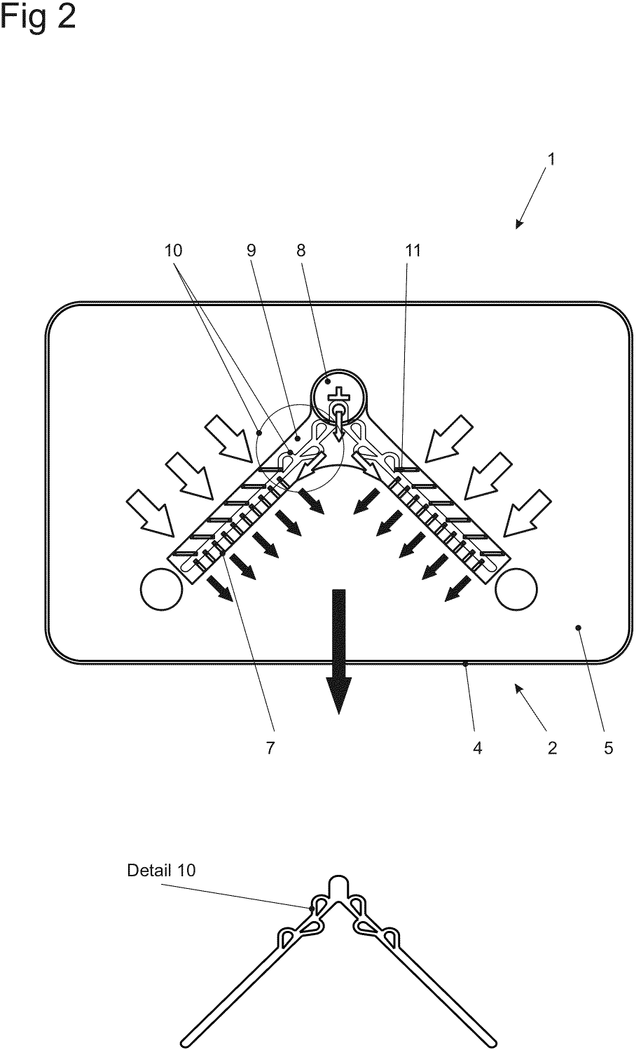

FIGS. 1 and 2 show a cleaning apparatus 1 for cleaning a mechanical cleaning arrangement 2 of a cleaning appliance 3, comprising a container 4 having a recess 5 for receiving the base member 6, which is provided with the cleaning arrangement 2, of the cleaning appliance 2.

The recess 5 is associated with a nozzle arrangement 7, wherein the nozzle arrangement 7 is connected in a flow-conducting manner to an inlet 8. The inlet 8 is in the form of a pipe coupling and protrudes in the form of a connection piece from the container 4. During the cleaning of the cleaning arrangement 2 there is introduced via the inlet 8 cleaning fluid which flows in the direction of the nozzle arrangement 7 and flows out through the nozzle arrangement 7.

The nozzle arrangement 7 comprises a number of nozzles which are arranged in a linear manner, wherein the nozzles of the nozzle arrangement 7 are arranged in a V-shaped manner when viewed from above. The nozzle arrangement 7 is connected to the inlet 8 by means of a channel 9. A flow-conducting device 10 in the form of a Tesla valve is arranged in the channel 9.

There are further arranged in the recess 5 projections 11 in the form of ribs which are arranged in each case adjacent to the nozzles of the nozzle arrangement 7. Accordingly, the ribs are arranged in the recess 5 in a comb-like manner.

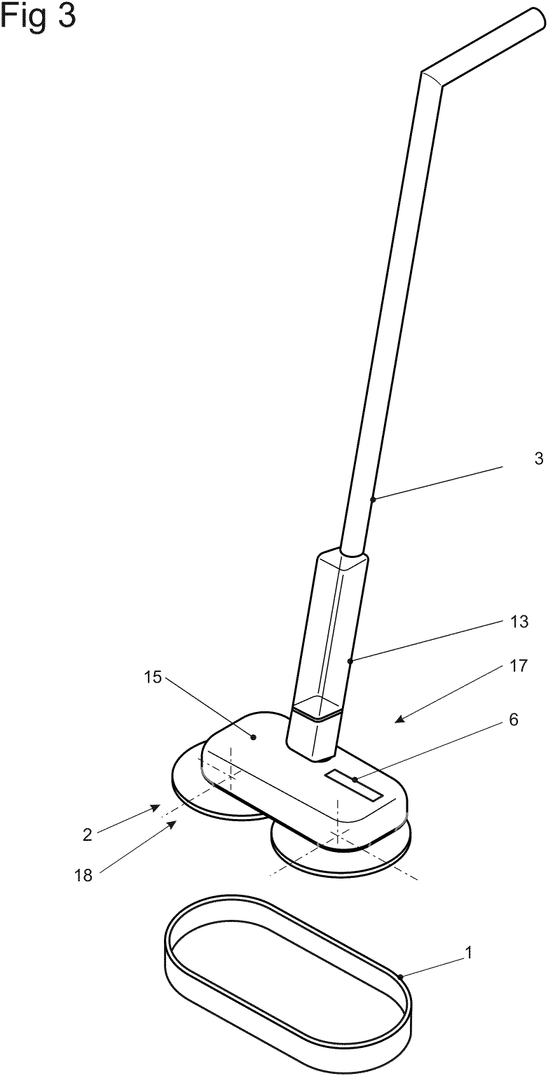

FIG. 3 shows a cleaning appliance 3 having a cleaning arrangement 2 which can be cleaned in the cleaning apparatus 1. The cleaning appliance 3 has a base member 6 which is provided with a mechanical cleaning arrangement 2 in the form of a rotatable brush arrangement. In the present embodiment, the cleaning arrangement 2 comprises two disk-like brushes which are rotatably arranged at the lower side of the base member 6. The rotation axes of the brushes are in this instance perpendicular to the lower side of the base member 6 or perpendicular to the floor to be cleaned.

According to an alternative embodiment, the cleaning arrangement 2 comprises one or more brush rollers which are rotatably associated with the lower side of the base member 6, wherein the brush rollers partially extend into the base member 6. The rotation axis of the brush rollers is parallel with the lower side or with the floor to be cleaned.

The cleaning appliance 3 is further provided with a suction device 5, wherein the suction device 15 has a suction opening 18 in the form of a suction slot. The suction opening 18 and the cleaning arrangement 2 are associated with the lower side of the base member 6. The suction device 15 receives soiled fluid and directs this fluid into a soiled water container, which is arranged inside the base member 6. The suction device 15 having a soiled water container is in this instance removably secured to the base member 6 in a housing unit.

The cleaning appliance 3 is provided with another device 16 for applying cleaning fluid to the floor to be cleaned. Furthermore, the cleaning appliance 3 is provided with electric motors for driving the cleaning arrangement 2 and the suction device 15, wherein the provision of the electrical energy is carried out by means of an accumulator which is arranged in the base member 6.

The cleaning appliance 3 further has a fluid tank 13, which is associated with an outlet 14 which can be connected to the inlet 8 in order to clean the cleaning arrangement. 2. The cleaning appliance 3 further has a pump apparatus 17 which can act on the fluid tank 13 with pressure. On the one hand, cleaning fluid can thereby flow out of the other device 16 at a high pressure and, on the other hand, it can leave the cleaning appliance 3 via the outlet 14 in order to subsequently leave the nozzle arrangement 7 of the cleaning apparatus 1 and to clean the cleaning arrangement 2.

The outlet 14 is in this instance arranged on the cleaning appliance 3 in such a manner that the outlet 14 independently contacts the inlet 8 of the cleaning apparatus 1 when the cleaning appliance 3 is inserted into the cleaning apparatus 1. There is further associated with the outlet 14 a valve arrangement which enables cleaning fluid to flow out of the outlet 14 only when the outlet 14 is connected to the inlet 8.

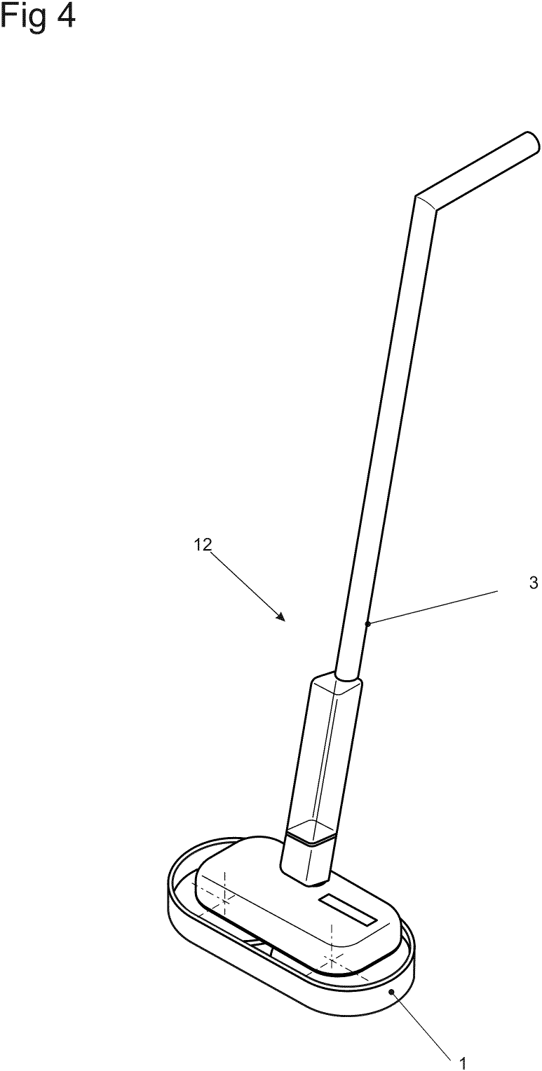

FIG. 4 shows a cleaning system 12 in which the cleaning appliance 3 is placed on the cleaning apparatus 1, wherein the outlet 14 of the fluid tank 13 contacts the inlet 8 of the cleaning apparatus. As a result of the fact that the cleaning fluid in the fluid tank 13 is under pressure, the cleaning fluid flows via the outlet 14, the inlet and the channel 9 in the direction of the nozzle arrangement 7 and is sprayed at that location in the direction of the cleaning arrangement 2.

The sprayed cleaning fluid is subsequently received by the suction device 15.

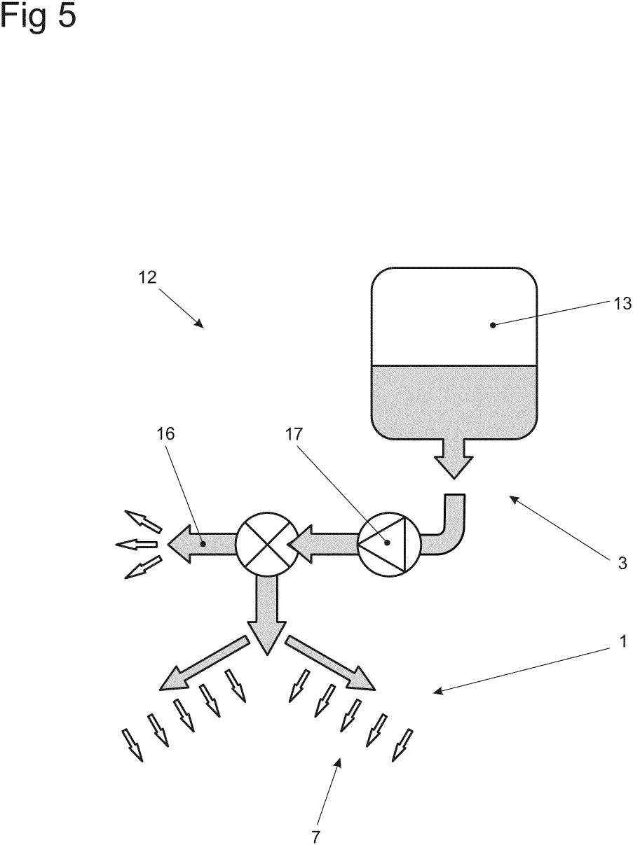

FIG. 5 shows a schematic drawing of the cleaning system 12 having a fluid tank 13, pump apparatus 17, device 16 for spraying cleaning fluid and nozzle arrangement 7.

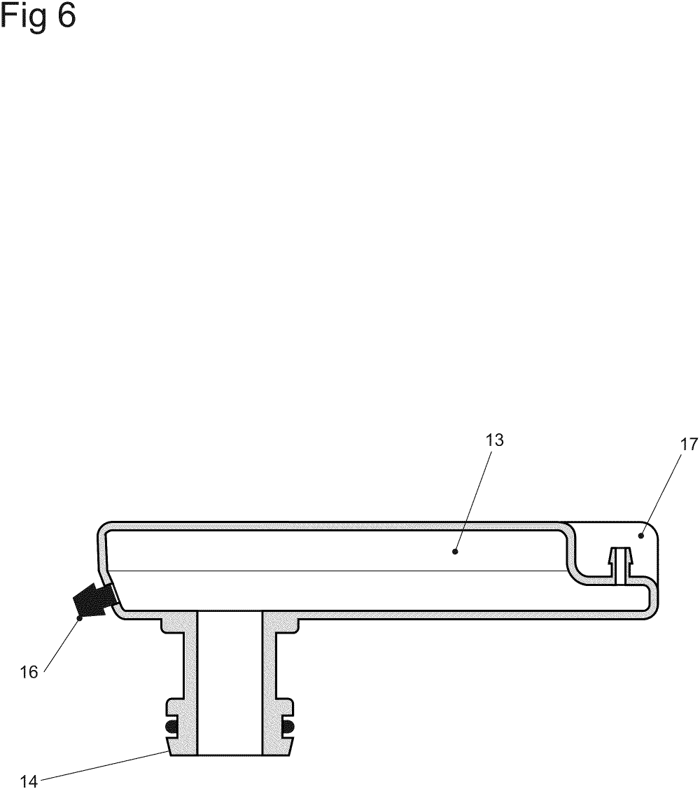

FIG. 6 shows in detail the fluid tank 13 of the cleaning appliance 3. The fluid tank 13 is a pressure tank and has an outlet 14, a device 16 for spraying cleaning fluid and a pump apparatus 17.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A cleaning system, comprising:
a cleaning appliance comprising a base member having a mechanical cleaning arrangement, and a fluid tank having an outlet; and
a cleaning apparatus for cleaning the mechanical cleaning arrangement, the cleaning apparatus comprising:
a container having a recess configured to receive the base member; and
a nozzle arrangement associated with the recess and connected to an inlet in a flow-conducting manner,
wherein the outlet of the fluid tank is connectable to the inlet.

2. The cleaning system of claim 1, wherein the inlet comprises a pipe coupling.

3. The cleaning system of claim 1, wherein the nozzle arrangement is connected to the inlet by at least one channel.

4. The cleaning system of claim 3, wherein at least one flow-conducting device is arranged in the channel.

5. The cleaning system of claim 4, wherein the at least one flow-conducting device comprises a Tesla valve.

6. The cleaning system of claim 4, wherein the at least one flow-conducting device comprises a valve arrangement.

7. The cleaning system of claim 1, wherein the recess is provided with projections.

8. (canceled)

9. (canceled)

10. The cleaning system of claim 1, wherein the fluid tankis actable on with pressure.
